(19) United States
(12) Patent Application Publication
(10) Pub. No.: US 2025/0165957 A1
(43) Pub. Date: May 22, 2025

(54) CRYPTOGRAPHIC ROOT OF IDENTITY

(71) Applicant: Sproquet Corp., New York, NY (US)

(72) Inventors: Steven Sprague, Richmond, MA (US); Michael Sprague, New York, NY (US)

(21) Appl. No.: 18/952,897

(22) Filed: Nov. 19, 2024

Related U.S. Application Data
(60) Provisional application No. 63/601,042, filed on Nov. 20, 2023.

(51) Int. Cl. G06Q 20/36; G06Q 20/38; H04L 9/30

(52) U.S. Cl. CPC G06Q 20/367; G06Q 20/389; H04L 9/3073

(57) ABSTRACT

A system using multi-signature wallets and blockchain keys to enable the creation of a company root identity that matches the documented corporate governance models recorded in the articles of incorporation. The registration of the public root identity key with the corporate registrar of record by filing a Doing Business As registration with the registrar using the Public key as the company name. The system supports multiple execution models to enable the binding of the corporate identity root to the existing digital systems using Cryptography to provide the forensic digital proof the process was permissioned by and bound to the corporate root-of-identity. A system that automatically validates the Chain of control back to the root assuring a relying party the transaction was authorized by the corporation and its policies.

### RELATED APPLICATION(S)

This application claims the benefit of U.S. Provisional Application No. 63/601,042, filed on Nov. 20, 2023, the entire teachings of which are incorporated herein by reference.

### BACKGROUND

The transition to digital transactions, video meetings, and global cross boarder business has made proving a corporate identity in any transaction increasingly difficult. The old models of physical buildings and business cards are not as useful when the workforce works remotely and is spread around the world.

### SUMMARY

The contemporary business landscape is undergoing a seismic shift towards digitalization, marked by the rapid evolution of global trade and commerce. This transformation has brought forth a critical need for robust corporate digital identity frameworks. Existing digital identity solutions primarily rely on personal identification like passports, state IDs, or email addresses, lacking a solid foundation for corporate authorization, control and validation.

The current scenario presents various challenges. Traditional certificate authorities that are often used for establishing corporate identities have proven cumbersome and are frequently underutilized due to their complexity. While these systems exist, they lack the necessary robustness and security features required for the modern digital era. As more business transactions occur on social networks and non-traditional platforms, the reliance on corporate domain and email addresses is failing at an accelerating rate.

Moreover, the world is witnessing an expanding digital ecosystem where corporate entities are operating across borders, necessitating an identity verification system that transcends geographical and bureaucratic barriers. This situation demands a new approach that seamlessly integrates corporate governance, security, and validation mechanisms into a single, reliable infrastructure—the corporate digital identity root.

While the world is awash in new schemes to establish and verify the digital identity of a person, the systems needed to establish and verify the digital identity of a company are less developed. The technologies of blockchain provide a new approach to corporate identity, governance, and validation.

To address such issues, an example embodiment can provide a corporate root-of-trust that preferably is solely controlled by the Enterprise, such that it is not issued, it is created. Example embodiments can build on a core foundation of blockchain technology the ability for the business to generate a unique key pair and record the public key on the blockchain. In one example preferred embodiment, the blockchain is a quantum-enhanced blockchain. The corporation has a self-defined governance model that must be applied to the use of the corporate digital identity and evidence of compliance with the governance model is critical to many third parties from partners to shareholders to regulators. Digital validation of the use of the corporate identity and the creation of persistent forensic evidence is critical to the operation of a company.

For example, an embodiment includes generating a private key and a public key, registering the public key as an identity of a company, registering an amendment to an incorporation document, where the incorporation document includes operating rules for the public key and private key including an operating model configured to protect the private key via a digital wallet, where the amendment includes information on the public key. The embodiment also references the creation of the public key to the public, and references how to verify the public key's authenticity as related to the company's digital identity.

An example embodiment includes using a decentralized application (DAPP) that is paired with a smart contract and a digital wallet to provide registration and revocation of credentials that are certified by the company's digital identity root, and providing both operational rolls and policies that are bound to the use of the issued public keys.

An example embodiment includes using a single transaction ID to link all of the processes in a transaction to a single identifier. The identifier may be configured with a zero-knowledge proof (ZKP). The resulting corporate root-of-trust ZKP identifier can be used to prove identity without disclosing sensitive information, such as biometric data or private keys.

An example embodiment includes using a third party to maintain and bind personal identity information or biometric data to individual keys used for authorization of the corporate identity root keys.

An example embodiment includes creating a second registered back up key that can used immediately in the case of the failure of the primary key.

An example embodiment includes registering the public root identity key with a corporate registrar of record by filling a Doing Business As registration with the registrar while using the public key as the company name.

An example embodiment includes examining the blockchain records and validating a root-of-identity for a transaction.

An example embodiment includes using additional embedded data in the blockchain record to enhance the information presented in a validation report.

An example embodiment includes using reference data embedded in the blockchain record to reference or link to external data sources that may or may not be cryptographically secured to enhance information presented in a validation report.

An example embodiment includes using embedded encryption or scrambling to protect the confidentiality of the data embedded within the blockchain records, where decryption keys may be provided to authorized validating parties.

An example embodiment includes using homomorphic encryption to assure the confidentiality of the data embedded within the blockchain records, where encrypted data can operate on, but remain encrypted within, a validation report.

An example embodiment includes using a validation script identifier that is embedded within a transaction record to identify a validation script that would be used to assemble a validation report.

An example embodiment includes binding the identity of the requesting party into the validation report to provide evidence of the person and time the validation report was requested and generated.

An embodiment includes creating a unique one time use key pair, including of a public key and a private key, and registering the public key on the blockchain using the identity root keys. The embodiment continues by recording additional information on the chain associated with a transaction to simplify the binding of transaction to the one time use key using blockchain to store the immutable record.

An example embodiment includes using a quick response (QR) code that represents the one-time key as a signature image in a third-party signing platform, and providing forensic evidence that the one-time key was used to sign a document and it is a one-time use key derived from an identity root key or a derived identity root key.

An example embodiment includes recording specific transaction and intent data at the time a one-time use key is requested, and binding the intended use to the key for future reference by a validator.

An example embodiment includes recording the results of a policy engine validating a pre-set list of policies before a one-time use key can be generated binding the policies to the key for future reference by a validator.

An example embodiment includes presenting, via a DAPP, the user with a required amount of tokens to receive a response, signing and submitting a smart message, via a user's digital wallet, to transfer the tokens, and using token transaction record as part of a cyber security assurance process to bind payment information into a secure transaction.

An example embodiment includes using a multi-signature transaction to incorporate proof of compliance to a list of policies. The embodiment continues by enabling a multi-signature digital wallet, upon registration, wherein at least one signature is controlled by a service server, establishing with the service server, via an owner of a private key, a list of policies that must be adhered to and verified prior to payment being confirmed, confirming the policy list, via the owner of the private key, with a multi-signature transaction registering the established list, initiating, via the owner, a transaction where the service server confirms a list of pre-established policies records are met, digitally signing the results, and confirming the multi-signature transaction for execution, and including, via the service server, the transaction hash and a signed manifest of policy controls into the information confirmed prior to the submission of the request to the service.

An example embodiment includes replacing specific cryptographic processes with quantum resistant models to enhance a resistance of a system over time, and using a quantum resistant solution as a basis for identity root keys.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a flow diagram of how the chain of trust is organized on a blockchain, according to an embodiment.

FIG. 2 is a flow diagram of the cycle of a transaction on the blockchain, according to an embodiment.

FIG. 3 is a simplified block diagram showing exemplary blockchain layers according to an embodiment.

FIG. 4 is a simplified block diagram of an example implementation of a network in communication with an embodiment.

FIG. 5 is a simplified block diagram of any internal structure of a computer/computing node in a processing environment of an embodiment.

### DETAILED DESCRIPTION

A description of example embodiments follows.

The mass availability of advanced artificial intelligence (AI) tools is increasing the threat landscape for impersonation with voice and video simulation that is difficult, if not impossible, for a human to detect. The rise of reliance on video meetings and social media communications channels dramatically shifts the landscape for potential fraud in transactions. As such, it is desirable for companies to have a failsafe technical solution to enhance transactional and digital assurance.

Technical solutions disclosed herein can address such issues and bridge the gap by offering a pioneering solution. In an example implementation, a platform may be designed to serve as a foundational root for corporate identities, employing blockchain technology to provide a secure, unalterable, and globally accessible identity verification system. By establishing a robust digital identity root, the platform can enable enterprises to validate their identities in a decentralized yet controlled manner, allowing for trustworthy interactions across various digital platforms.

The need for a corporate digital identity root becomes more pronounced as traditional business paradigms, such as physical infrastructure and face-to-face interactions, give way to virtual landscapes and remote operations. In an example embodiment, a solution can be provided that not only addresses the current inadequacies in digital identity but also anticipates and prepares for the future, where robust, universally recognized digital identities will be fundamental to global enterprise operations.

The market is ripe for a transformative solution that harmonizes the complexities of corporate identity, compliance, and security in the digital space. The disclosed solution is poised to fill this void by providing an innovative digital identity solution that will not only meet the current market demands but also adapt and evolve to accommodate the dynamic future of global business interactions.

Embodiments disclosed herein may be built on technical foundations that combine the principles of self-sovereign identity, single use tokens, blockchain, and roots of trust. The goal is simple-to integrate easy to manage solutions that provide the digital assurance that the enterprise requires for verifiable identity. Many systems today are built on keys that the enterprise creates and internally secures themselves, however these systems then lack a digital foundation of a strong root of trust and verifiable chain of authorization.

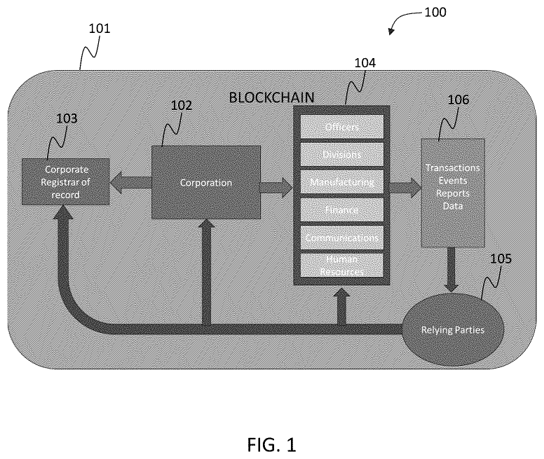

FIG. 1 is a diagram 100 of how the chain of trust is organized on a blockchain 101, according to an embodiment. In one example embodiment, the blockchain 101 may be configured as a quantum-enhanced blockchain. The quantum-enhanced blockchain may be configured with quantum enhancement to protect a root identity key and authorization keys. In an example, a quantum-enhanced blockchain may use the quantum hash function (QHF), a quantum digital signature, (QDS), and proof of authority (PoA) consensus mechanism. A quantum-enhanced blockchain can enable the system to be provide robust security against quantum computing and conventional attacks, such as attacks on public-key signatures, hash functions, public-key digital signatures, and consensus algorithms.

In an example implementation, the blockchain may be configured with a quantum key distribution system, which includes a transmitter, a receiver to create a quantum access network (QAN). In the QAN, for example, a plurality of transmitters may be connected via a device to enable the quantum key distribution system. In another example, the receiver may be configured with several optical fiber communication interfaces, and a quantum key distribution system, where transmitters may be are connected via these interfaces to facilitate generation of a unique key pair.

In an example implementation, an entity, such as a company may generate a unique key pair and records the public key on the blockchain 101 (or use the quantum key distribution system of the blockchain). As part of this process, the company/corporation 102 establishes a key governance model that matches the company's administration governance model that is established by the shareholders 104 of the company. After the keys are created, the company 102 amends its corporate registrar of record 103 to include a registration of the human readable form of the public key. By using the immutable properties of a blockchain network, the relying parties 105 are assured that any data, signature, or service is bound to the corporate root identity. In addition, this supplies the relying parties with digital evidence 106 of transactions, events, reports, data, etc., assuring them that their transactions are with the appropriate corporate root identity.

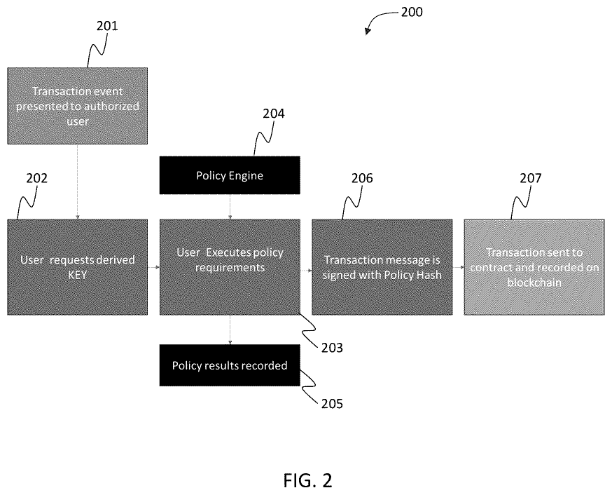

FIG. 2 is a flow diagram 200 of the cycle of a transaction on the blockchain, according to an embodiment. First, a transaction event 201 is presented to an authorized user. The user then requests 202 a derived key. The user executes 203 a policy requirement, which is enforced by the policy engine 204, and the policy results are recorded 205. Next, the transaction message is signed 206 with the policy hash, and the transaction is sent to the contract and recorded 207 on the blockchain.

According to an embodiment, the disclosed solution is based on three core pillars of technology.

The first of which being registration with custody and control. According to an embodiment, the disclosed solution provides the tools, process, and infrastructure to create a digital identity on the blockchain, and to properly register the public key with the corporate registrar in the corporation's local jurisdiction. An example disclosed solution will provide consulting and software to assure that the board of directors, or the partners, have shared control of the private key that matches the filed governance documents.

The second core pillar is operations. The company provides a suite of applications, decentralized applications (DAPPS), and other tools that integrate a blockchain identity into the issuance and assurance of enterprise credentials and single use tokens. Enabling support for document signing, encrypted messaging, certificates, application programming interface (API) keys, email infrastructure and domain validation. The result provides evidence on chain that can be validated by third parties to assure that exposed enterprise systems have identities that are anchored in, or assured by, the corporate root identity. These technical solutions and integration with third parties will mature over time as the use of a corporate root is adopted.

The third core pillar is validation. According to an embodiment, the disclosed solution will provide a range of services to enable third parties to easily discover and verify that data, a signature, or a service is bound to the corporate root identity. This assures that a service, signature presented, or data delivered is authorized and intended. The use of blockchain to share validation information provides an always on and immutable solution. This assures relying parties that the validations performed in real time are always available for audit, or to provide digital evidence of an event.

Enabling end to end digital assurance applies not only to company communications and contracts but can also be used to support product identity and integrity. According to an embodiment, the disclosed solution expects that the corporate identity root will find its way into international standards, such as ISO 9001 quality systems, as well as software upgrades, product tokenization and other manufacturing systems as well. From AI to internet of things (IOT) there is a material need to provide assurance that the information and products provided are from the intended enterprise.

Example implementations of embodiments described herein may, but is not limited to, using derived identities for contracts, product assurance, API integrity, data quality, government compliance, audit, and customer assurance, or any combination thereof. The digital future is here, and it is time to benefit from the reduction in cost and the efficiency that digital can provide, while avoiding the fraud and impersonation that is taking place everywhere.

### A Foundation for Quantum Resistant Identity

Similar to the original “Y2K” concern of the late nineties, the risk of quantum computing impacting all certificate-based identity systems is growing every day. The underlying technologies of the disclosed solution will follow National Institute of Standards and Technology (NIST) guidance on quantum resistant algorithms and best practices. Every enterprise will ultimately need to address the challenges of the changing security market and establishing a securely managed digital root will be part of every solution.

An example implementation of a corporate root-of-identity using blockchain keys and multi-signature wallets is herein disclosed. The company constructs a multi-signature wallet according to the amended articles of incorporation to define the process for how a key is permissioned. Then, according to an embodiment, using the blockchain wallet to construct a new key pair for the organization. The private key is held confidentially in the wallet. The public key will then be published with the corporate registrar of record or with any other corporate regulator. The company may sign the revised articles of incorporation, that define the rules for how keys are used and managed, before publishing the updated articles of incorporation to the corporate registrar to assure the integrity and authenticity of the revised articles.

An example implementation of deriving keys from the corporate identity root is accomplished by creating a new key and then authorizing the new key with attributes approved by the corporate root-of-identity. The board of directors or principles defined in the articles of incorporation will use their private keys to authorize the corporate wallet to perform the desired action of certifying the new credentials. These self-sovereign attributes can then be verified by any relying party.

An example implementation of creating new keys derived from the corporate root-of-identity may require additional policy or governance steps. These process steps or documents are executed according to the policy. Each step of the policy may be independently signed and logged in a combined hash as the independent policy steps are signed, and the resulting accumulated hash is recorded as part of the transaction when the corporate root-of-identity is used to certify the derived keys. The saved location of the log file is recorded in the transaction and can be shared with relying parties automatically or when approved.

An example implementation of the system may use effectivity dates and expiration dates that overlap to assure that the executives, divisions, or systems always have access to root keys or derived keys that are not expired.

An example implementation of the system may include third party validation data for the principles authorizing the corporate identity root keys. This validation result can be recorded as part of the certification process and bound to the approval transaction. Assuring the information for each of the authorized parties has been verified.

The embodiments of the current invention may incorporate multiple cryptographic process steps to construct a chain of trust back to the corporate root identity for legacy or non-compatible systems by recording each step on the blockchain even as the underlying keys may change in type, length, or specific algorithm.

### Validation

An example implementation of the system includes a validation process. The validation process will be provided by a specific transaction ID and will use this information to scan the blockchain and construct a detailed report on the chain of trust that validates that the transaction is authentic. The report may include information that is not on the blockchain but is signed data associated with the transaction and stored by a third party or by the enterprise.

In some example implementation of the system, validation data may be encrypted and require access to decryption keys in order to view the full details of the report. These keys may be managed by a third party or by the corporation.

In some embodiments of the system, a unique global validation identifier is recorded as part of the creation of a derived credential. The identifier will enable the selection of the compatible validation process. The validation process will be recorded on the blockchain to assure tamper resistance.

In some embodiments of the system, real time monitoring of the transaction may be executed using third party tools or AI to assure transactions are operating as required, with only notifications being provided if validation data is not as expected.

In some embodiments of the invention, validation reports will be signed and recorded on the blockchain to provide forensic evidence of the performance of the specific validation and its results.

In an example implementation, the blockchain 101 may be configured as a quantum-enhanced machine learning blockchain. In this example, the blockchain may be configured with a virtual machine (and/or an oracle) or kernel executing quantum algorithms that provides identity management and validation tasks via machine learning, such as verifying and examining the blockchain records and validating a root-of-identity for a transaction. A root-of-identity (i.e. corporate root of trust or digital identity root) for a corporate entity may be validated and further synthesized into a validation report. An encoder may be configured and preprocess as root-of-identity data set into a quantum computer to make it accessible for quantum information processing. Quantum information processing routines may be applied to the root-of-identity data set and the result of the quantum computation may be measured by the quantum system to create the validated root-of-identity. In this way, the outcome of the measurement of a qubit can reveal the result of a binary classification task of the validated root-of-identity. The resulting qubit of the validated root-of-identity can be mapped to Hilbert space. By mapping it to the Hilbert space, complex value data from the validated root-of-identity can be used in a quantum binary classifier in order to take advantage of Hilbert space, and quantum mechanics properties can be utilized such as superposition, entanglement, interference the quantum binary classifier to improve processing speed to examine and verify a digital identity root in short period of time. See, e.g. Park, Daniel K.; Blank, Carsten; Petruccione, Francesco (2020-07-27). “The theory of the quantum kernel-based binary classifier”. Physics Letters A. 384 (21): 126422. 2020. ISSN 0375-9601. S2CID 215238793, which is incorporated herein by reference in its entirety.

### The Use of Tokens to Integrate Payment and Policy as Part of Service

Embodiments of the present invention may use tokens to pay for service. The system can be configured to request payment for service. The user would be required to make payment using a blockchain token designed for that purpose and compatible with the system. The smart contract for the service is programed with the destination wallet address for payment. Once the user configures the details of the request and submits the transaction to the service, they will be required to sign a blockchain transaction with their wallet and transfer a sufficient number of tokens to pay for the service. The service will receive the tokens in their designated wallet and confirm the receipt of payment on the blockchain.

Some embodiments of the service would use a multi-signature wallet to enable acceptance of payment only after certain cybersecurity policies have been verified. The user may execute a process to set up a muti-signature wallet, and the transaction server confirms the configuration. At the time of registration, the procedure to establish policies applicable to all transactions, or the method to supplement transactionally specific policies, would be recorded using the service and confirmed by the user's private key. Once the multi-signature service is established, the user can then submit the transaction using the multi-signature address and keys.

The service would execute policies that are preconfigured by the service at multi-signature registration and/or as requested by the user for a specific transaction. These policies would be verified and logged; and upon completion of the policies, or upon meeting an agreed threshold of the policies, the service server would use its private key to confirm the payment transaction and allow it to proceed. If the policies failed to validate, then the service would reject the transaction and the payment would be returned to the user's account.

Proof the payment and policies have been executed would be captured by the service server in log files and digitally hashed. The digitally signed hash of these files would then be included in the health and integrity information log for the specific transaction and appended to any other cyber assurance data in the response.

### Quantum Protection of Keys and Transactions

Some embodiments of the system may use methods to enhance the public private keys used for identity with technology to increase the resistance to a quantum computing breaking the cryptography of the transaction.

The teachings of all patents, published applications and references cited herein are incorporated by reference in their entirety.

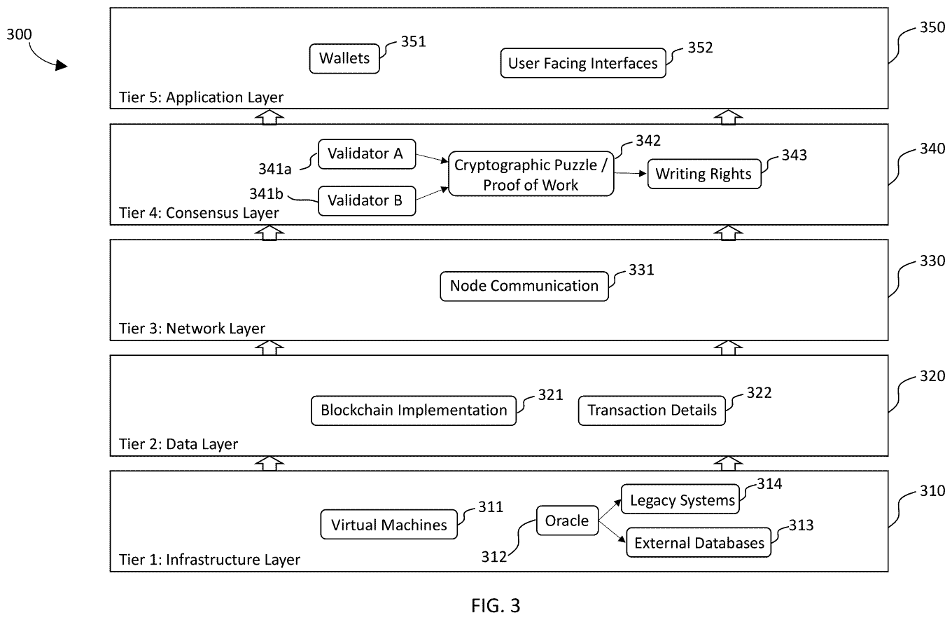

FIG. 3 is a simplified block diagram showing exemplary blockchain layers 300 according to an embodiment. Blockchain layers 300 may include infrastructure (tier 1) layer 310, data (tier 2) layer 320, network (tier 3) layer 330, consensus (tier 4) layer 340, and application (tier 5) layer 350. The infrastructure layer 310 may be a hardware/software/firmware layer and may include one or more virtual machines (VMs) 311 and/or one or more oracles 312. A virtual machine (VM) 311 may provide a runtime environment for transaction execution in the blockchain. In an embodiment, a VM 311 may be, for example, stack-based and may enable untrusted code to be executed by a global peer-to-peer (P2P) network of computers. An oracle 312 may provide a third-party service that connects smart contracts executing on the blockchain with off-chain data sources. For example, an oracle 312 may query, verify, and/or authenticate one or more external data sources for the system 100 (FIG. 1) and/or system 200 (FIG. 2). According to an embodiment, external data sources may include, e.g., one or more legacy systems 314 and/or one or more external compliance systems and/or databases 313. In an example, the blockchain or any sidechains may be configured to execute embodiments disclosed herein, such as (1) creating corporate root-of-trust (root of digital identity, (2) computationally using quantum enhancement to protect a root identity key and authorization keys from compromise, (3) enable the binding of the corporate identity root to the existing digital systems using Cryptography to provide the forensic digital proof the process was permissioned by and bound to the corporate root-of-identity, and/or (4) computationally creating a derived one time use credential from corporate identity root keys or derived keys.

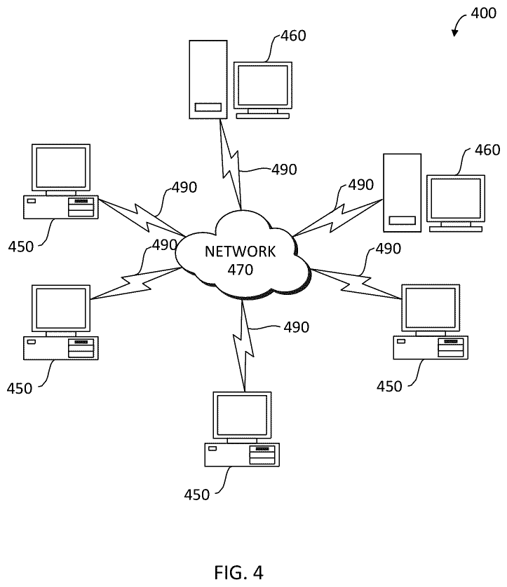

An example implementation of system 100 (FIG. 1) and/or system 200 (FIG. 2) may be implemented in a software, firmware, or hardware environment. FIG. 4 illustrates one such example digital processing environment 400 in which embodiments of system 100 and/or system 200 may be implemented. Client computer(s)/device(s) 450 and server computer(s)/device(s) 460 provide processing, storage, and input/output (I/O) devices executing application programs and the like.

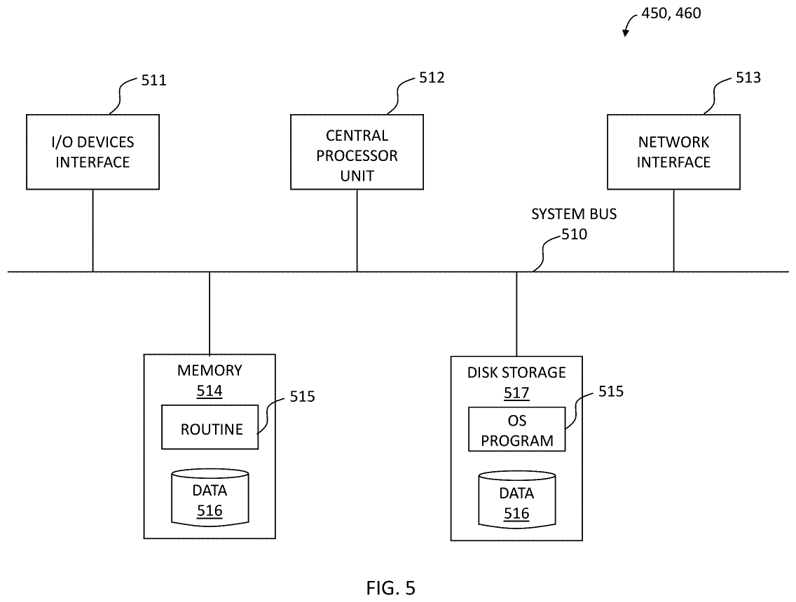

Client computer(s)/device(s) 450 may be linked 490 directly or through communications network 570 to other computing devices, including other client computer(s)/device(s) 450 and server computer(s)/device(s) 460. Referring to FIGS. 4 and 5 (the latter described in more detail hereinbelow), network 470 utilizes system 100 and/or system 200 according to an embodiment of the invention, for providing privacy for transfer of digital assets, e.g., held in digital wallet(s).

The communication network 470 may be part of a wireless or wired network, a remote access network, a global network (e.g., the Internet), a worldwide collection of computers, local area networks (LANs) or wide area networks (WANs), and gateways, routers, and switches that may use a variety of known protocols (e.g., TCP/IP, Bluetooth®, etc.) to communicate with one another. Communication network 470 may also be a virtual private network (VPN) or an out-of-band (OOB) network or both. Further, communication network 470 may take a variety of forms, including, but not limited to, a blockchain network, a distributed ledger network, a data network, voice network (e.g., landline, mobile, etc.), audio network, video network, satellite network, radio network, and pager network. Other known electronic device/computer network architectures are also suitable. For example, client computer(s)/device(s) 450 may include nodes which run user applications that enable a user to communicate with an application to determine whether a user meets a work requirement. A blockchain network may be configured on each user device. Client computers of the computer-implemented system 100 (FIG. 1) and/or 200 (FIG. 2) may be configured with a trusted execution environment (TEE) or trusted platform module (TPM), where the application may be run and digital assets, e.g., held in digital wallet(s).

FIG. 5 is a block diagram of any internal structure of a computing/processing node (e.g., client computer(s)/device(s) 450 or server computer(s)/device(s) 460) in the processing environment 400 of FIG. 4, which may be used to facilitate displaying audio, image, video, or data signal information. Each computer/device 450, 460 in FIG. 5 may contain a system bus 510, where a bus is a set of actual or virtual hardware lines used for data transfer among components of a computer or processing system. System bus 510 may essentially be a shared conduit that connects different elements of a computer system (e.g., processor, disk storage, memory, I/O ports, etc.), thereby enabling transfer of data between elements or components.

Continuing with FIG. 5, attached to system bus 510 is an I/O device interface 511 for connecting various input and output devices (e.g., keyboard, mouse, touch screen interface, displays, printers, speakers, audio inputs and outputs, video inputs and outputs, microphone jacks, etc.) to a computer/device 450, 460. Network interface 513 may allow a computer/device to connect to various other devices attached to a network, for example network 470 of FIG. 4. Memory 514 may provide volatile storage for computer software instructions 515 and data 516 used in some embodiments to implement software modules/components of system 100 (FIG. 1) and/or system 200 (FIG. 2).

Software components of system 100 and/or 200, module(s)/engine(s)/system(s), software components, the policy enforcement system, a minimax recursive algorithm, encoder/decoder, Trusted Execution Environment (TEE), blockchain Layer 1 virtual machine (VM), oracle, kernel, wallet interface, applets, authentication site, cybersecurity controller, service applications, and the like) described herein may be configured using any programming language known in the art, including any high-level, object-oriented programming (OOP) language, such as Python or Solidity. The computer-implemented system may include instances of processes that enable execution of transactions and recordation of transactions. It should be understood that the terms “transaction” and “exchange” are herein used interchangeably, when used within a context of digitally transferring items of value, such as digital assets, collateral assets, and/or collateral tokens, among entities associated with a blockchain network, e.g., L1 blockchain(s). The computer-implemented system 100 and/or 200 may also include instances of a scoring engine and/or encoders/decoders, which can be implemented by, e.g., a server 460 or a client that communicates with the server 460, using, for example, secure sockets layer (SSL), Hypertext Transfer Protocol Secure (HTTPS), or any other suitable protocol known to those of skill in the art.

In an example mobile implementation, a mobile agent implementation of embodiments may be provided. A client-server environment may be used to enable mobile services using a network server, e.g., server 460. It may use, for example, the Extensible Messaging and Presence Protocol (XMPP) protocol, or any other suitable protocol known to those of skill in the art, to tether an engine/agent 515 on a user device 450 to a server 460. The server 460 may then issue commands to the user device on request. The mobile user interface framework to access certain components of computer-implemented system 100 (FIG. 1) and/or 200 (FIG. 2) may be based on, e.g., XHP, Javalin, and/or Wireless Universal Resource File (WURFL), or other suitable known framework(s), interface(s), or combinations thereof. In another example mobile implementation for the iOS operating system (OS) and its corresponding application programming interface (API), the Cocoa Touch API may be used to implement the client-side components 515 using Objective-C or any other suitable known high-level OOP language that adds Smalltalk-style messaging to the C programming language.

Disk storage 517 may provide non-volatile storage for computer software instructions 515 (equivalently “OS program”) and data 516 may be used to implement embodiments of system 100 and/or 200. The system may include disk storage accessible to a server computer 460. The server computer may maintain secure access to records associated with system 100 and/or 200. Central processing unit (CPU) 512 may also be attached to system bus 510 and provide for execution of computer instructions. In one example embodiment, the CPU 512 is a secure cryptoprocessor implemented as a dedicated microprocessor configured to execute the compliance enforcement system. The cryptoprocessor may be specialized to execute cryptographic algorithms within hardware to support the compliance enforcement system. Functions include such things as accelerating encryption algorithms that verify compliance of encoded rules related to an NFT asset, enhanced tamper, and intrusion detection, enhanced data, key protection and security enhanced memory access and I/O to facilitate transactions across multiple blockchain systems.

In some embodiments, processor routines 515 and data 516 may be computer program products. For example, aspects of system 100 and/or 200 may include both server-side and client-side components.

In other embodiments, authenticators/attesters may be contacted via, e.g., blockchain gaming systems, instant messaging applications, video conferencing systems, VoIP (voice over IP) systems, etc., all of which may be implemented, at least in part, in software 515, 516. Further, in yet other embodiments, client-side components interfacing with system 100 and/or 200 may be implemented as an application programming interface (API), executable software component, or integrated component of the OS configured to provide access to an electronic wallet on a Trusted Platform Module (TPM) executing on a client device 450.

In an embodiment, software implementations 515, 516 may be implemented as a computer-readable medium capable of being stored on a storage device 517, which provides at least a portion of the software instructions for system 100 and/or 200. Executing instances of respective software components of system 100 and/or 200, such as instances of system 100 and/or 200, may be implemented as computer program products 515, and may be installed by any suitable software installation procedure, as is well known in the art. In another embodiment, at least a portion of the system software instructions 515 may be downloaded over a wired and/or wireless connection via, for example, a browser SSL session or through an app (whether executed from a mobile or other computing device). In other embodiments, system 100 and/or 200 software components 515 may be implemented as a computer program propagated signal product embodied on a propagated signal on a propagation medium (e.g., a radio wave, an infrared wave, a laser wave, a sound wave, or an electrical wave propagated over a global network such as the Internet, or other network(s) known in the art).

In one embodiment, a compliance enforcement system is implemented as an embedded virtual machine (VM), preferably executing on one or more cryptoprocessors configured to support efficient and scalable processing of application-to-blockchain and blockchain-to-blockchain transactions. The cryptoprocessor may be a dedicated computer-on-a-chip or microprocessor for carrying out cryptographic transaction operations, embedded in a hardware security module (HSM) with security measures providing failsafe tamper resistance. The embedded cryptographic processor can be configured to output decrypted data onto a bus in a secure environment, in that embedded cryptoprocessor does not output decrypted data or decrypted program instructions in an environment where security cannot be maintained. The embedded cryptoprocessor does not reveal keys or executable instructions on a bus, except in encrypted form, and zeros keys by attempts at probing or scanning.

While example embodiments have been particularly shown and described, it will be understood by those skilled in the art that various changes in form and details may be made therein without departing from the scope of the embodiments encompassed by the appended claims.

1-17. (canceled)

18. A computer-implemented method, the method comprising:
computationally using quantum enhancement to protect a root identity key and authorization keys from compromise by:
replacing specific cryptographic processes with quantum resistant models to enhance a resistance of a system over time; and
using a quantum resistant solution as a basis for identity root keys.

19-24. (canceled)

25. A computer system comprising:
a root of trust identity validation computer system configured to iteratively create a respective digital identity on a blockchain system for respective computing entities using a unique cryptographic key pair,
wherein the root of trust identity validation computer system is configured to create a first digital entity for a first computing entity by:
generating a first cryptographic key pair including a first private key and a first public key for the first computing entity;
registering the first public key of the first computing entity on a blockchain computer system, the registered first public key creating a cryptographic binding of the first digital identity on the blockchain of the first computing entity; and
registering an operating model pertaining to the first computing entity on the blockchain computer system, wherein the registered operating model is digitally signed by the first cryptographic key pair, the operating model being configured with operating rules controlling use via multi-signature digital wallet control system of the first public key and the first private key by the first computing entity;
wherein the root of trust identity validation computer system is configured to create a second digital entity for a second computing entity by:
generating a second cryptographic key pair including a second private key and a second public key for the second computing entity;
registering the public key of the second computing entity on a blockchain computer system, the registered public key of the second computing entity creating a cryptographic binding of the second digital identity on the blockchain of the second computing entity; and
registering an operating model pertaining to the second computing entity on the blockchain computer system, wherein the registered operating model is digitally signed by the second cryptographic key pair, the operating model being configured with operating rules controlling use via multi-signature digital wallet control system of the second public key and the second private key by the computing entity;
the root of trust identity validation computer system configured to respond to queries from third party computer systems to validate creation of the first public key and how to verify the first public key's authenticity as related to the first digital identity of the first computing entity.

26. The computer system of claim 25 wherein the operating rules are an amendment to an incorporation document of the computing node; and
the root of trust identity validation computer system being further configured to computationally process a digital amendment to an incorporation document of the first computing node, the digital amendment causing the registering of the first operating model.

27. The computer system of claim 25 wherein root of trust identity validation computer system is further configured to:
use a decentralized application (DAPP) that is paired with a smart contract and a digital wallet to provide registration and revocation of credentials that are certified by the first digital identity of the first computing node; and
provide both operational rolls and policies that are bound to the use of the issued public keys.

28. The computer system of claim 25 wherein root of trust identity validation computer system is further configured to:
use a single transaction ID to link all of the steps in a transaction to a single identifier.

29. The computer system of claim 25 wherein root of trust identity validation computer system is further configured to:
use a third-party computing system to maintain and bind personal identity information or biometric data to individual keys used for authorization of the entity's identity root keys; and
create of a second registered back up key that is useable immediately in the case of the failure of the private key.

30. The computer system of claim 25 wherein root of trust identity validation computer system is further configured to:
register the first public key with a corporate registrar of record by filling a Doing Business As registration with the registrar while using the public key as the entity name.

31. The computer system of claim 25 wherein root of trust identity validation computer system is further configured to:
examine the blockchain records and validate a root-of-identity for a transaction; and
use additional embedded data in the blockchain record to enhance the information presented in a validation report.

32. The computer system of claim 25 wherein root of trust identity validation computer system is further configured to:
use reference data embedded within the blockchain record to reference or link to external data sources that is not cryptographically secured to enhance information presented in a validation report; and
use embedded encryption or scrambling to protect the confidentiality of the data embedded within the blockchain records, wherein decryption keys may be provided to authorized validating parties.

33. The computer system of claim 25 wherein root of trust identity validation computer system is further configured to use homomorphic encryption to assure confidentiality of the data embedded within the blockchain records, wherein encrypted data can operate on, but remain encrypted within, a validation report.

34. The computer system of claim 25 wherein root of trust identity validation computer system is further configured to use a validation script identifier that is embedded within a transaction record to identify a validation script that would be used to assemble a validation report.

35. The computer system of claim 27 wherein root of trust identity validation computer system is further configured to computationally bind the identity of the requesting party of the third-party system into the validation report to provide evidence of a personally identify and time the validation report was requested and generated.

36. The computer system of claim 25 wherein root of trust identity validation computer system is further configured to:
using a quick response (QR) code that represents the one-time key as a signature image in a third-party signing platform; and
provide the forensic evidence that the one-time key was used to sign a document and it is a one-time use key derived from an identity root key or a derived identity root key.

37. The computer system of claim 25 wherein root of trust identity validation computer system is further configured to:
record specific transaction and intent data at the time a one-time use key is requested; and
bind intended use to the key for future reference by a validator.

38. The computer system of claim 25 wherein root of trust identity validation computer system is further configured to record the results of a policy engine validating a pre-set list of policies before a one-time use key can be generated binding the policies to the key for future reference by a validator.

39. The computer system of claim 25 wherein root of trust identity validation computer system is a virtual machine in communication with the blockchain network, the virtual machine (1) computationally using quantum enhancement to protect a root identity key and authorization keys from compromise, (2) enable the binding of the corporate identity root to the existing digital systems using cryptography to provide the forensic digital proof the process was permissioned by and bound to the corporate root-of-identity, and/or (3) computationally creating a derived one time use credential from corporate identity root keys or derived keys.

40. The computer system of claim 25 wherein the blockchain is quantum-enhanced blockchain that uses the quantum hash function (QHF), a quantum digital signature, (QDS), and proof of authority (PoA) consensus algorithm.

41. The computer system of claim 25 wherein root of trust identity validation computer system is further configured to:
computationally enabling payment for service using blockchain tokens by:
presenting, via a DAPP, the user with a required amount of tokens to receive a response;
signing and submitting a smart message, via a user's digital wallet, to transfer the tokens;
using token transaction record as part of a cyber security assurance process to bind payment information into a secure transaction;
using a multi-signature transaction to incorporate proof of compliance to a list of policies;
enabling a multi-signature digital wallet, upon registration, wherein at least one signature is controlled by a service server;
establishing with the service server, via an owner of a private key, a list of policies that must be adhered to and verified prior to payment being confirmed;
confirming the policy list, via the owner of the private key, with a multi-signature transaction registering the established list;
initiating, via the owner, a transaction where the service server confirms a list of pre-established policies records are met, digitally signing the results, and confirming the multi-signature transaction for execution;
including, via the service server, the transaction hash and a signed manifest of policy controls into the information confirmed prior to the submission of the request to the service.

42. The computer system of claim 25 wherein the digital identity root is a cryptographic binding of the entity's identity root of trust, such that the cryptographic binding is configured as an encapsulation of the transaction with a binding of the transaction to the one time use key, stored on the blockchain as an immutable record.

43. The computer system of claim 25 wherein root of trust identity validation computer system is further configured computationally enable payment for digital identity validation service using blockchain tokens by:
presenting, via a DAPP, the user with a required amount of tokens to receive a response;
signing and submitting a smart message, via a user's digital wallet, to transfer the tokens;
using token transaction record as part of a cyber security assurance process to bind payment information into a secure transaction.

44. The computer system of claim 25 wherein root of trust identity validation computer system is further configured to:
use a multi-signature transaction to incorporate proof of compliance to a list of policies;
enable a multi-signature digital wallet, upon registration, wherein at least one signature is controlled by a service server;
establish with the service server, via an owner of a private key, a list of policies that must be adhered to and verified prior to payment being confirmed;
confirming the policy list, via the owner of the private key, with a multi-signature transaction registering the established list;
initiate, via the owner, a transaction where the service server confirms a list of pre-established policies records are met, digitally signing the results, and confirming the multi-signature transaction for execution;
include, via the service server, the transaction hash and a signed manifest of policy controls into the information confirmed prior to the submission of the request to the service.

45. The computer system of claim 25 wherein root of trust identity validation computer system is further configured to:
computationally use quantum enhancement to protect a root identity key and authorization keys from compromise by:
replace specific cryptographic processes with quantum resistant models to enhance a resistance of a system over time; and
use a quantum resistant solution as a basis for identity root keys.

46. A computer-implemented method, the method comprising:
computationally enabling payment for service using blockchain tokens by:
presenting, via a DAPP, the user with a required amount of tokens to receive a response;
signing and submitting a smart message, via a user's digital wallet, to transfer the tokens;
using token transaction record as part of a cyber security assurance process to bind payment information into a secure transaction;
using a multi-signature transaction to incorporate proof of compliance to a list of policies;
enabling a multi-signature digital wallet, upon registration, wherein at least one signature is controlled by a service server;
establishing with the service server, via an owner of a private key, a list of policies that must be adhered to and verified prior to payment being confirmed;
confirming the policy list, via the owner of the private key, with a multi-signature transaction registering the established list;
initiating, via the owner, a transaction where the service server confirms a list of pre-established policies records are met, digitally signing the results, and confirming the multi-signature transaction for execution;
including, via the service server, the transaction hash and a signed manifest of policy controls into the information confirmed prior to the submission of the request to the service.
